(19) United States
(12) Patent Application Publication
(10) Pub. No.: US 2024/0295772 A1
(43) Pub. Date: Sep. 5, 2024

(54) BACKLIGHT MODULE AND DISPLAY DEVICE

(71) Applicant: Enplas Corporation, Kawaguchi-shi (JP)

(72) Inventors: Masaki NOGAMI, Kawaguchi-shi (JP); Yuki FUJII, Kawaguchi-shi (JP)

(21) Appl. No.: 18/516,596

(22) Filed: Nov. 21, 2023

(30) Foreign Application Priority Data
Mar. 3, 2023 (CN) 202320402341.6

(51) Int. Cl. G02F 1/13357

(52) U.S. Cl. CPC G02F 1/133606; G02F 1/133605; G02F 1/133609; G02F 1/133614

(57) ABSTRACT

A backlight module and a display device. The backlight module includes: at least one substrate; a plurality of light-emitting devices configured on the at least one substrate and configured in a matrix shape at intersections of orthogonal virtual lines, and having: a light-emitting element configured for emitting a first color light; a light-transmitting member configured for converting the first color light into a second color light; a beam control component configured for diffusing and emitting the second color light; a reflection member configured at least among the plurality of light-emitting devices; a light-diffusing member configured on a light-emitting side of the light-emitting devices; wherein a surface of the reflection member facing the light-diffusing member has colored areas AA that render an optical complementary color of a first color, and each of the colored areas AA is located at least at a gravity center of an area enclosed by four adjacent light-emitting devices.

### TECHNICAL FIELD

The present application relates to the technical field of display, and in particular to a backlight module and a display device.

### BACKGROUND

With the development of electronic technology and the increasing requirements of consumers for display screen size and image quality, liquid crystal display (LCD) has become the mainstream development trend in the industry. A backlight module in the LCD usually includes an edge-lit backlight module and a direct-type backlight module. Compared to the edge-type backlight module, the direct-type backlight module can significantly improve the brightness and color display of a panel.

In the related art, a light emitting diode (LED) is generally used as a light source of the backlight module. Specifically, the backlight module includes a substrate, a plurality of light-emitting devices and a diffusion plate, wherein the light-emitting devices are located at one side of the substrate, and each of the light-emitting devices includes a LED and a diffusion lens. The LED is installed at one side of the substrate. The diffusion lens is disposed on the LED. The diffusion plate is located at one side of the light-emitting device away from the substrate and has a distance from the substrate.

In the light-emitting devices, by arranging the diffusion lens, a light-emitting angle of the LED can be increased to diffuse the light, thereby facilitating reducing of the number of the arranged light-emitting devices and saving of energy consumption. However, with the development of thin and light display devices, a distance between the substrate and the diffusion plate is small, which results in uneven chromaticity as well as light spots easily appearing among the light-emitting devices, thereby resulting in poor display effect.

### SUMMARY

An object of the present application is to provide a backlight module and a display device, which can improve the presence of light spots as well as the uneven chromaticity among light-emitting devices and improve the display effect. The specific technical solutions are as follows:

An embodiment of a first aspect of the present application provides a backlight module. The backlight module includes: at least one substrate; a plurality of light-emitting devices configured on the at least one substrate and configured in a matrix shape at intersections of orthogonal virtual lines, and having: a light-emitting element configured for emitting a first color light, a light-transmitting member configured for converting the first color light into a second color light, and a beam control component configured for diffusing and emitting the second color light; a reflection member configured at least among the plurality of light-emitting devices; a light-diffusing member configured on a light-emitting side of the light-emitting devices; wherein a surface of the reflection member facing the light-diffusing member has colored areas AA that render an optical complementary color of a first color, and each of the colored areas AA is located at least at a gravity center of an area enclosed by four adjacent light-emitting devices.

Furthermore, the backlight module according to the embodiments of the present application may have the following additional technical features.

In some embodiments of the present application, the plurality of light-emitting devices are installed at one side of the substrate; the light-transmitting member covers the light-emitting element, and the beam control component is covered on an exterior of the light-emitting element and the light-transmitting member with a gap therebetween; the reflection member is a reflection sheet, which is installed on the substrate and on the same side as the light-emitting devices; the reflection member at least covers an area of the substrate other than the plurality of light-emitting devices; the orthogonal virtual lines include a plurality of first direction virtual lines extending along a first direction and a plurality of second direction virtual lines extending along a second direction perpendicular to the first direction; the plurality of light-emitting devices are respectively located in the reflection component at intersections of a grid formed by the first direction virtual lines and the second direction virtual lines.

In some embodiments of the present application, the light-diffusing member has a predetermined distance from the substrate, and the predetermined distance is greater than a size of the beam control component in a thickness direction of the backlight module and less than or equal to 0.26 times a maximum distance between adjacent light-emitting devices.

In some embodiments of the present application, the optical complementary color of the first color is printed in the colored areas.

In some embodiments of the present application, the colored areas are circular areas, rectangular areas or oval areas.

In some embodiments of the present application, the first color light is a blue light, the light-transmitting member is yellow, the second color light is a white light, and the colored areas present yellow.

In some embodiments of the present application, the beam control component is a diffusion lens.

In some embodiments of the present application, the reflection member is arranged with through-holes through which the light-emitting devices pass.

In some embodiments of the present application, the reflection member is a surface at one side of the substrate installed with the light-emitting devices and coated with a reflective material.

In some embodiments of the present application, the light-diffusing member is a diffusion plate.

In some embodiments of the present application, a distance between two adjacent light-emitting devices in the first direction is equal, and a distance between two adjacent light-emitting devices in the second direction is equal.

In the embodiment of the present application, the colored areas are arranged on the surface at one side of the reflection member facing the light-diffusing member. The colored areas that render an optical complementary color of a first color are each located at least at a gravity center of an area enclosed by the four adjacent light-emitting devices. Therefore, after being illuminated by the light, the colored areas are presented as the second color with the bias toward the color of the light-transmitting member, so that the chromaticity of the colored areas is consistent with that of the other areas of the reflection member, thereby facilitating improving of the presence of light spots as well as the uneven chromaticity among the respective light-emitting devices and improving of the display effect.

The embodiments of a second aspect of the present application provide a display device including a backlight module according to any one of the above embodiments.

Since the display device according to the embodiments of the present application has a backlight module described in the first aspect, the display device also has the beneficial effects of any one of the embodiments in the first aspect, which will not be repeated herein.

Of course, it is not necessary that the implementation of any one of the products of the present application need achieve all of the advantages described above at the same time.

### BRIEF DESCRIPTION OF THE DRAWINGS

In order to describe the technical solutions of embodiments of the present application or of the prior art more clearly, a simple introduction of the drawings required in the description of the embodiments and of the prior art will be given. Obviously, the drawings described below are just for some embodiments of the present application and other drawings may be obtained by those of ordinary skills in the art based on these drawings.

FIG. 1 is a chromaticity diagram of a backlight module in the related art;

FIG. 2 is a chromaticity curve of a backlight module in the related art;

FIG. 3 is a schematic structure of a backlight module in one embodiment of the present application;

FIG. 4 is a top view of the backlight module of the embodiment shown in FIG. 3 (a light diffusion member is not shown);

FIG. 5 is a top view of the backlight module shown in FIG. 4 without the installation of a beam control component;

FIG. 6 is a chromaticity diagram of the backlight module of the embodiment shown in FIG. 3;

FIG. 7 is a chromaticity curve of the backlight module of the embodiment shown in FIG. 3;

FIG. 8 is a top view of the backlight module shown in FIG. 5 without the installation of a reflection member;

FIG. 9 is a top view of a backlight module in another embodiment of the present application without the installation of the reflection member and the beam control component;

FIG. 10 is a schematic diagram of the structure of one of the light-emitting devices of the backlight module shown in FIG. 8 (the beam control component is not shown);

FIG. 11 is a top view of a backlight module in yet another embodiment of the present application without the installation of the beam control component;

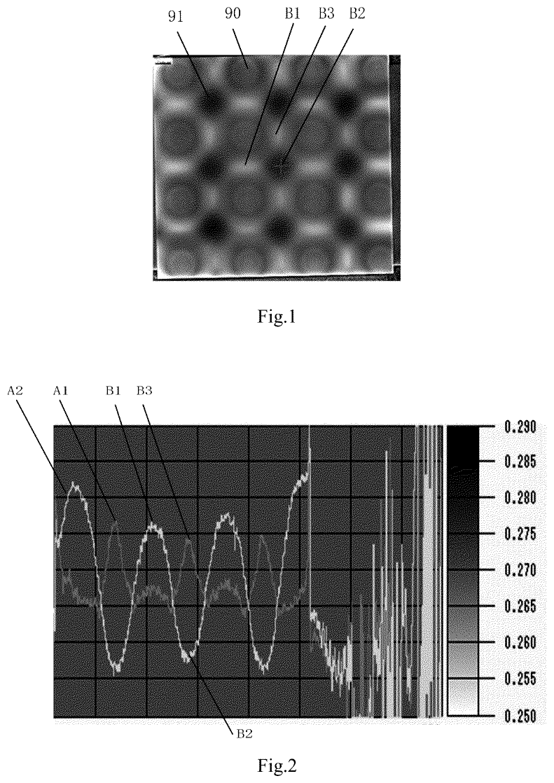

In FIGS. 1-2: light-emitting device 90; light spot 91;

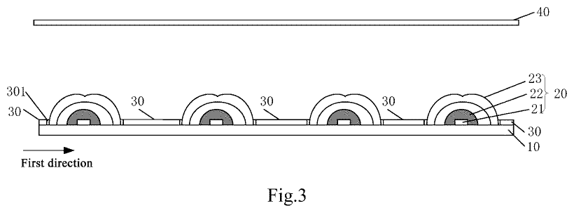

In FIGS. 3-11: substrate 10; light-emitting device 20; light-emitting element 21; light-transmitting member 22; beam control component 23; reflection member 30; through-hole 301; light-diffusing member 40; first direction virtual line L1; second direction virtual line L2; colored area AA.

### DETAILED DESCRIPTION

The technical solutions in the embodiments of the present application will be described clearly and completely below with reference to the drawings in the embodiments of the present application.

As stated in the background, in the related art, the backlight module includes a substrate, a plurality of light-emitting devices and a diffusion plate. In the light-emitting devices, by arranging the diffusion lens, a light-emitting angle of the LED can be increased to diffuse the light, thereby facilitating reducing of the number of the arranged light-emitting devices and saving of energy consumption. However, as display devices become thinner and lighter, a distance between the substrate and the diffusion plate is small, which results in uneven chromaticity as well as light spots easily appearing between the light-emitting devices, thereby resulting in poor display effect.

Specifically, in the related art, in order to provide a white light, the light-emitting device generally includes an LED chip and a phosphor covering the LED chip. The LED chip is used to emit a blue light, and the phosphor is a yellow phosphor. The color (i.e., blue) of the light emitted by the LED chip and the color (i.e., yellow) of the phosphor are optically complementary to each other. Therefore, the blue light can be converted into white light after passing through the phosphor. As shown in FIG. 1, in the related art, light-emitting devices 90 are usually arranged on a reflection sheet in an array. The inventor found that when the distance between the light-emitting devices 90 is large and the distance between the substrate and the diffusion plate is small, a light spot 91 is prone to appearing at the gravity center of an area enclosed by four light-emitting devices 90. The light spot 91 is presented as blueish white with a low chromaticity, and the other areas between the respective light-emitting devices 90 are presented as white with a bias towards the color of the phosphor (i.e., yellowish white) with a high chromaticity. FIG. 2 is chromaticity curves at some positions in FIG. 1, wherein the horizontal axis corresponds to a transverse size of the backlight module shown in FIG. 1, and the vertical axis represents the chromaticity. Two chromaticity curves are shown in FIG. 2, wherein curve A1 is the chromaticity curve directly above an area in which the second row of light-emitting devices 90 are located, and curve A2 is the chromaticity curve of an area between the second row of light-emitting devices 90 and the third row of light-emitting devices 90 in the vertical direction in FIG. 1. On the curve A2, a chromaticity value at position B1 is high, while a chromaticity value at position B2 is low, and the difference between the chromaticity value at position B2 and the chromaticity value at position B3 on curve A1 corresponding to B2 is relatively large, approximately 0.017. The position B1 is in a non-spot area and the position B2 is in a spot area. Due to different chromaticities in different regions, in the related art, the uneven chromaticity and the light spots are displayed between the respective light-emitting devices, and the display effect is poor.

In view of this, as shown in FIGS. 3 to 5, a backlight module is proposed in the first aspect of the present application. The backlight module comprises at least one substrate 10, a plurality of light-emitting devices 20, a reflection member 30, and a light-diffusing member 40. The plurality of light-emitting devices 20 are configured on the at least one substrate 10 and configured in a matrix shape at intersections of orthogonal virtual lines, and have: a light-emitting element 21 for emitting a first color light; a light-transmitting member 22 for converting the first color light into a second color light; and a beam control component 23 for diffusing and emitting the second color light. The reflection member 30 is at least configured among the plurality of light-emitting devices 20. The light-diffusing member 40 is configured on a light-emitting side of the light-emitting device 20. A surface of the reflection member 30 facing the light-diffusing member 40 has colored areas AA that render an optical complementary color of a first color, and each of the colored areas AA is located at least at a gravity center of an area enclosed by four adjacent light-emitting devices 20.

In the embodiment of the present application, the surface at one side of the reflection member 30 facing the light-diffusing member 40 is arranged with the colored areas AA. The colored area AA is located at a gravity center of an area enclosed by four adjacent light-emitting devices 20. The colored areas AA render the optical complementary color of the first color. Therefore, after being illuminated by the light, the colored areas AA are presented as a second color with a bias toward the color of the light-transmitting member 22, so that the chromaticity of the colored areas AA is consistent with that of the other areas of the reflection member 30, thereby facilitating improving of the presence of light spots as well as the uneven chromaticity between the respectively light-emitting devices 20 and improving the display effect.

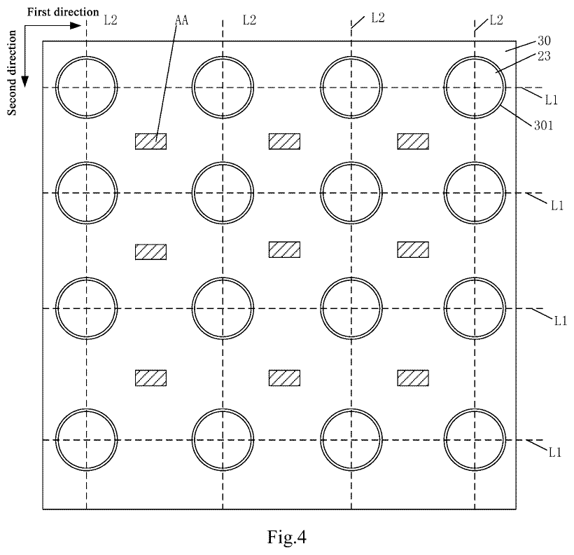

Specifically, in a first example, as shown in FIGS. 3 and 4, the plurality of light-emitting devices 20 are installed at one side of the substrate 10; the light-transmitting member 22 covers the light-emitting element 21, and the beam control component 23 is covered on an exterior of the light-emitting element 21 and the light-transmitting member 22 with a gap therebetween; the reflection member 30 is a reflection sheet, which is installed on the substrate 10 and on the same side as the light-emitting devices 20; the reflection member 30 covers an area of the substrate 10 other than the plurality of light-emitting devices 20; the orthogonal virtual lines include a plurality of first direction virtual lines L1 extending along a first direction and a plurality of second direction virtual lines L2 extending along a second direction perpendicular to the first direction; the plurality of light-emitting devices 20 are respectively located in the reflection component 30 at intersections of a grid formed by the first direction virtual lines L1 and the second direction virtual lines L2.

It should be noted that in the embodiment of the present application, since the reflection member 30 covers an area of the substrate 10 other than the plurality of light-emitting devices 20, the colored areas AA must not present under the plurality of light-emitting devices 20.

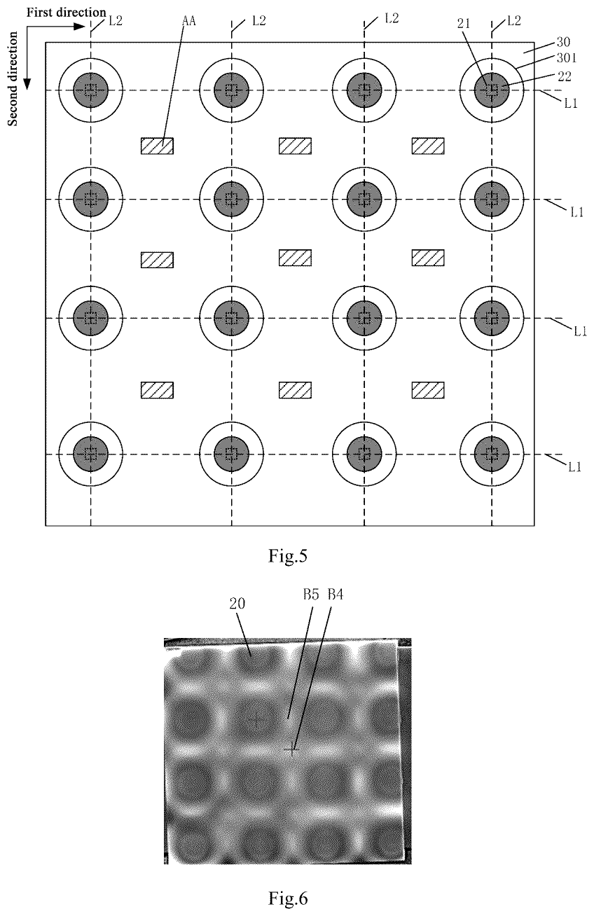

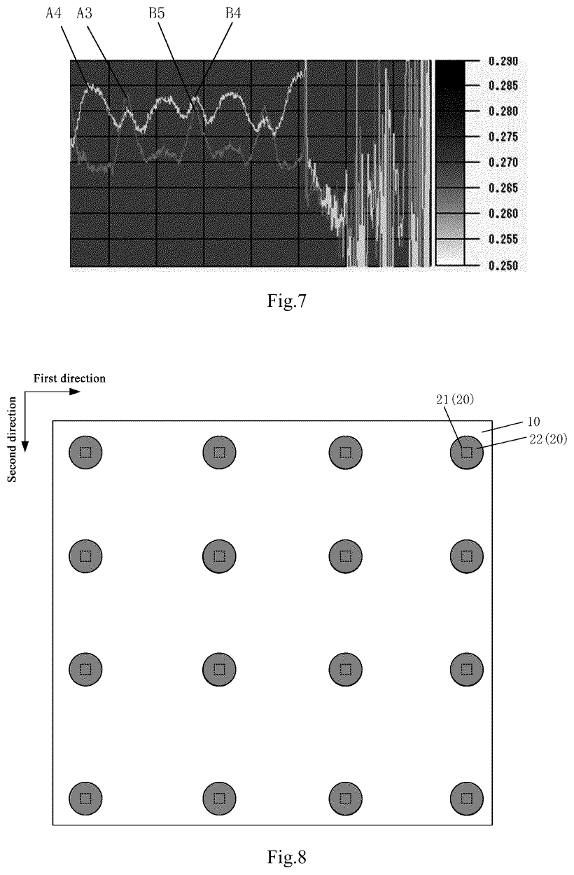

According to an experimental verification of the inventor, as shown in FIG. 6, in the embodiment of the present application, by arranging the colored area AA, which renders the optical complementary color of the first color, at a gravity center of an area enclosed by four adjacent light-emitting devices 20, the light spot at the area enclosed by the four light-emitting devices 20 is improved after being illuminated by the light. FIG. 7 are chromaticity curves of the backlight module shown in FIG. 6, wherein the horizontal axis corresponds to a transverse size of the backlight module shown in FIG. 7, and the vertical axis represents the chromaticity. Two chromaticity curves are shown in FIG. 7, wherein curve A3 is the chromaticity curve directly above an area in which the second row of light-emitting devices 20 as shown in FIG. 2 are located, and curve A4 is the chromaticity curve of an area between the second row of light-emitting devices 20 and the third row of light-emitting devices 20 in the backlight module shown in FIG. 2. Position B4 is located in the colored area AA, and the position B4 corresponds to the position B2 in FIG. 1. On the curve A4, a chromaticity value at the position B4 is improved, and the difference between the chromaticity value at the position B4 and the chromaticity value at the corresponding position B5 on the curve A3 is reduced to 0.01. Therefore, the light spots and the uneven chromaticity among the light-emitting devices 20 are improved significantly, and the display effect is improved accordingly.

It should be noted that when two color lights in optics are mixed in a suitable proportion to produce a white sensation, the two colors are optically complementary to each other, for example, an optical complementary color of blue is yellow.

Furthermore, it should be noted that in the embodiment of the present application, the colored areas AA are not located within the projection area of the beam control component 23 on the reflection sheet 30.

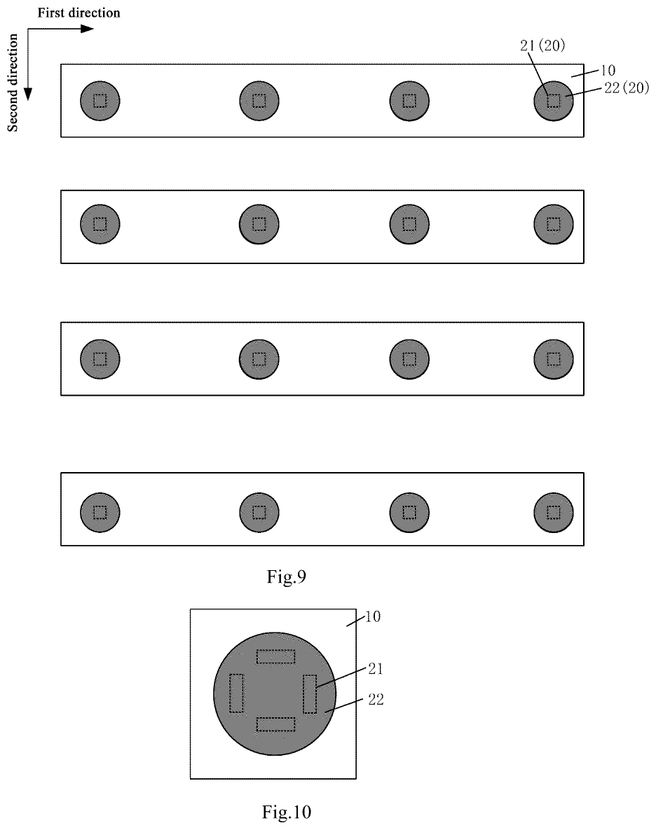

In some embodiments of the present application, as shown in FIG. 8, only one substrate 10 may be arranged in the backlight module. Therefore, the surface area of the substrate 10 is larger, and the plurality of light-emitting devices 20 are arranged on the one substrate 10. Alternatively, as shown in FIG. 9, the substrate 10 is a strip-shaped substrate which extends in the first direction, and a plurality of strip-shaped substrates are arranged at intervals in the second direction, and the plurality of light-emitting devices 20 are arranged uniformly on each of the strip-shaped substrates, respectively. The present application does not limit this.

In some embodiments of the present application, the light-emitting element 21 may be an LED chip. In the embodiments as shown in FIGS. 5 and 8, each light-emitting device 20 includes only one light-emitting element 21. In the embodiment as shown in FIG. 10, each light-emitting device 20 may include a plurality of light-emitting elements 21. The present application does not limit this.

In some embodiments of the present application, the light-transmitting member 22 may be a phosphor.

In some embodiments of the present application, the light-diffusing member 40 has a predetermined distance from the substrate 10, and the predetermined distance is greater than a size of the beam control component 23 in a thickness direction of the backlight module and less than or equal to 0.26 times a maximum distance between the adjacent light-emitting devices 20. Therefore, the light diffusion effect can be ensured, and the thickness size of the backlight module is also reduced, thereby facilitating the lightness and thinness of the display device.

Further, the predetermined distance is greater than the size of the beam control component 23 in the thickness direction of the backlight module and greater than or equal to 0.1 times the maximum distance between the adjacent light-emitting devices 20. Therefore, this facilitates improving of the display effect.

Preferably, the predetermined distance is greater than the size of the beam control component 23 in the thickness direction of the backlight module and greater than or equal to 0.15 times the maximum distance between the adjacent light-emitting devices 20.

Preferably, the predetermined distance is less than or equal to 0.19 times the maximum distance between the adjacent light-emitting devices 20.

In some embodiments of the present application, the light-diffusing member 40 is a diffusion plate, which is arranged facing the light-emitting devices 20 and has a predetermined distance from the substrate 10. Therefore, the light-diffusing member 40 can fully diffuse and transmit the light emitted from the light-emitting devices 20, thereby realizing a softer and more uniform irradiation effect.

In some embodiments of the present application, the optical complementary color of the first color is printed in the colored areas AA. By printing, a thickness of the colored areas AA can be thinner so that the impact on the optical path can be reduced. Specifically, the raw material for printing may be a pigment.

In other embodiments of the present application, a thin sheet is affixed to the colored areas AA. A surface of the thin sheet is presented as the optical complementary color of the first color.

In the embodiment shown in FIGS. 4 to 5, the colored areas AA are rectangular areas. Since the area enclosed by the four light-emitting devices 20 is rectangular, the coloring areas AA are arranged as matching rectangular areas. Therefore, the colored areas AA can be better adapted to the positions of the light-emitting devices 20.

In other embodiments of the present application, the coloring areas AA are circular areas or oval areas.

In other embodiments of the present application, the periphery of the coloring area AA may also be other shapes, such as a polygon or irregular shape. The present application does not limit this.

In some embodiments of the present application, the first color light is a blue light, the light-transmitting member 22 is yellow, the second color light is a white light, and the colored areas AA present yellow. By setting the first color light as the blue light and the light-transmitting member 22 as yellow, the blue light can be converted into the white light after passing through the light-transmitting member 22, so that the backlight module can be used to provide the white light. By presenting the colored areas AA in yellow, the colored areas AA can present a yellowish white color after being irradiated by the light, so as to be consistent with the chromaticity of the other areas of the reflection member 30, which facilitates improving of the light spots and the uneven chromaticity and improving of the display effect.

In the embodiment shown in FIGS. 4 to 5, a distance between two adjacent light-emitting devices 20 in the first direction is equal, and a distance between two adjacent light-emitting devices 20 in the second direction is equal. Therefore, it is convenient for the arrangement of the light-emitting devices 20 and the colored areas AA.

In a specific embodiment, the distance between two adjacent light-emitting devices 20 in the first direction is 150 mm, and the distance between two adjacent light-emitting devices 20 in a second direction is 140 mm, the colored area AA is a square area, and the length of the colored area AA is 25 mm.

In other embodiments of the present application, the distance between the adjacent light-emitting devices 20 in the first direction may be unequal; and the distance between the adjacent light-emitting devices 20 in the second direction may also be unequal. The present application does not limit this.

In some embodiments of the present application, the beam control component 23 is a diffusion lens. The diffusion lens can diffuse the second color light, thereby facilitating reducing of the number of the arranged light-emitting devices 20 and reducing of the cost.

In the embodiment shown in FIGS. 4 to 5, the reflection member 30 is arranged with through-holes 301 through which the light-emitting devices 20 pass. In the embodiment of the present application, the reflection member 30 may be a reflection sheet, and by arranging the through-holes 301 on the reflection sheet, it is convenient to operate the whole reflection sheet when assembling, so that the assembling process is simple and the operation is convenient.

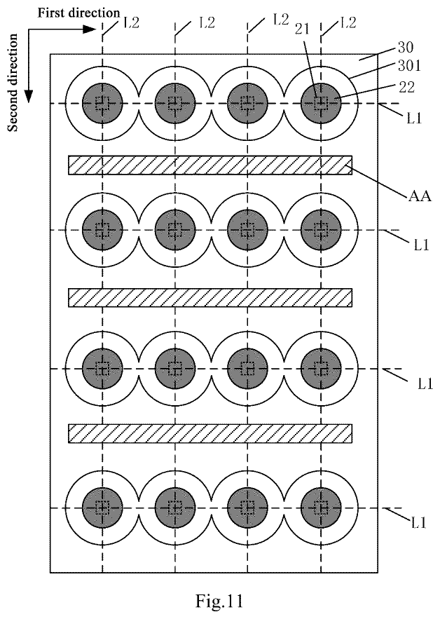

As shown in FIG. 11, in yet another embodiment of the present application, unlike the embodiment shown in FIG. 5, the distance between two adjacent light-emitting devices 20 in the first direction is smaller and the distance between two adjacent light-emitting devices 20 along the second direction is larger. Accordingly, the through-holes 301 arranged on the reflection member 30 may be arranged immediately adjacent to each other in the first direction, and the distance between the through-holes 301 in the second direction is larger than the distance between the through-holes 301 in the first direction. In this case, the colored areas AA are located in the middle of a spacing area of the two adjacent rows of light-emitting devices 20 along the second direction, and each of the colored areas AA extends along the first direction from an edge in proximity to the one side of the reflection member 30 to an edge in proximity to the other side of the reflection member 30 to form a colored band.

In the embodiment of the present application, considering that in the case that the distance between two adjacent light-emitting devices 20 in the first direction is very small or no spacing is arranged therebetween, the light spot mainly appears in the middle of the spacing area of the two adjacent rows of light-emitting devices 20 along the second direction, a coloring area AA is arranged in the middle of the spacing area of the two adjacent rows of light-emitting devices 20 along the second direction, such that the light spot in the area is improved after being illuminated by the light.

It will be appreciated that the middle of the spacing area of the two adjacent rows of light-emitting devices 20 along the second direction includes a gravity center of the area enclosed by the four adjacent light-emitting devices 20.

In other embodiments of the present application, unlike the embodiment shown in FIG. 5 and the embodiment shown in FIG. 11, the reflection member 30 is not only located in the area among the light-emitting devices 20, but also extends into the interior of the light-emitting devices 20 and is located under the beam control component 23.

In other embodiments of the present application, unlike the embodiment shown in FIG. 5 and the embodiment shown in FIG. 11, the reflection member 30 is not a reflection sheet arranged additionally, but rather a surface at one side of the substrate 10 installed with the light-emitting devices 20 and coated with a reflective material, which may be a resist with a good reflective property. It will be appreciated that in the embodiment, the reflection member 30 is located not only in the area among the light-emitting devices 20, but also under the light-emitting devices 10.

The embodiments of a second aspect of the present application provide a display device comprising a backlight module in any one of the above embodiments.

In the embodiment of the present application, the display device includes the backlight module, in which the colored areas AA are arranged on the surface at one side of the reflection member 30 facing the light-diffusing member 40. The colored areas AA that render an optical complementary color of a first color are each located at least at a gravity center of an area enclosed by the four adjacent light-emitting devices 20. Therefore, after being illuminated by the light, the colored areas AA are presented as the second color with the bias toward the color of the light-transmitting member 22, so that the chromaticity of the colored areas AA is consistent with that of the other areas of the reflection member 30, thereby facilitating improving of the presence of light spots as well as the uneven chromaticity among the respective light-emitting devices 20 and improving of the display effect.

It should be noted that, the relationship terms herein such as “first”, “second” and the like are only used to distinguish one entity or operation from another entity or operation, but do not necessarily require or imply that there is actual relationship or order between these entities or operations. Moreover, the terms “comprise(s)”, “include(s)” or any other variants thereof are intended to cover non-exclusive inclusions, so that processes, methods, articles or devices including a series of elements include not only those elements listed but also those not specifically listed or the elements intrinsic to these processes, methods, articles, or devices. Without further limitations, elements defined by the sentences “comprise(s) a . . . ” or “include(s) a . . . ” do not exclude that there are other identical elements in the processes, methods, articles, or devices which include these elements.

All the embodiments are described in corresponding ways, same or similar parts in each of the embodiments can be referred to one another, and the parts emphasized are differences to other embodiments. In particular, for embodiments of the system, since they are substantially similar to the embodiments of the method, their description is relatively simple, and for the related aspects, one only needs to refer to portions of the description of the embodiments of the method.

The embodiments described above are merely preferred embodiments of the present application, and not intended to limit the scope of the present application. Any modifications, equivalents, improvements or the like within the spirit and principle of the application should be included in the scope of the application.

What is claimed is:

1. A backlight module, wherein the backlight module comprises:
at least one substrate;
a plurality of light-emitting devices configured on the at least one substrate and configured in a matrix shape at intersections of orthogonal virtual lines, and having:
a light-emitting element configured for emitting a first color light;
a light-transmitting member configured for converting the first color light into a second color light; and
a beam control component configured for diffusing and emitting the second color light;
a reflection member configured at least among the plurality of light-emitting devices; and
a light-diffusing member configured on a light-emitting side of the light-emitting devices;
wherein a surface of the reflection member facing the light-diffusing member has colored areas (AA) that render an optical complementary color of a first color, and each of the colored areas (AA) is located at least at a gravity center of an area enclosed by four adjacent light-emitting devices.

2. The backlight module as claimed in claim 1, wherein
the plurality of light-emitting devices are installed on a surface at one side of the substrate;
the light-transmitting member covers the light-emitting element, and the beam control component is covered on an exterior of the light-emitting element and the light-transmitting member with a gap therebetween;
the reflection member is a reflection sheet, which is installed on the substrate and on the same side as the light-emitting devices; the reflection member at least covers an area of the substrate other than the plurality of light-emitting devices; and
the orthogonal virtual lines include a plurality of first direction virtual lines (L1) extending along a first direction and a plurality of second direction virtual lines (L2) extending along a second direction perpendicular to the first direction; the plurality of light-emitting devices are respectively located in the reflection component at intersections of a grid formed by the first direction virtual lines (L1) and the second direction virtual lines (L2).

3. The backlight module as claimed in claim 1, wherein the light-diffusing member has a predetermined distance from the substrate, and the predetermined distance is greater than a size of the beam control component in a thickness direction of the backlight module and less than or equal to 0.26 times a maximum distance between adjacent light-emitting devices.

4. The backlight module as claimed in claim 1, wherein the optical complementary color of the first color is printed in the colored areas (AA).

5. The backlight module as claimed in claim 1, wherein the colored areas (AA) are circular areas, rectangular areas or oval areas.

6. The backlight module as claimed in claim 1, wherein the first color light is a blue light, the light-transmitting member is yellow, the second color light is a white light, and the colored areas (AA) present yellow.

7. The backlight module as claimed in claim 1, wherein the beam control component is a diffusion lens.

8. The backlight module as claimed in claim 2, wherein the reflection member is arranged with through-holes through which the light-emitting devices pass.

9. The backlight module as claimed in claim 1, wherein the reflection member is a surface at one side of the substrate installed with the light-emitting devices and coated with a reflective material.

10. The backlight module as claimed in claim 1, wherein the light-diffusing member is a diffusion plate.

11. The backlight module as claimed in claim 2, wherein a distance between two adjacent light-emitting devices in the first direction is equal, and a distance between two adjacent light-emitting devices in the second direction is equal.

12. A display device, wherein the display device comprises the backlight module as claimed in claim 1.
